(19) United States
(12) Patent Application Publication
(10) Pub. No.: US 2008/0044663 A1
(43) Pub. Date: Feb. 21, 2008

(54) Dual layer ceramic coating

(75) Inventors: Melvin Freling, West Hartford, CT (US); Kevin W. Schlichting, Storrs, CT (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/506,681

(22) Filed: Aug. 18, 2006

(51) Int. Cl. B32B 17/06

(52) U.S. Cl. 428/426

(57) ABSTRACT

A turbine engine component comprises a substrate, a bond coat applied to a surface of the substrate, a first ceramic layer having a cracked structure applied on top of the bond coat, and a second ceramic layer having a cracked structure applied on top of the first ceramic layer.

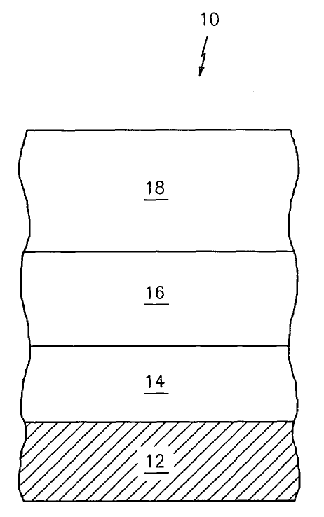

### BACKGROUND

(1) Field of the Invention

The present invention relates to a dual layer ceramic coating applied to a turbine engine component such as a blade, a vane, a combustor panel, or a seal.

(2) Prior Art

Thermal barrier coatings are used to provide insulation for metallic components that operate at elevated temperatures. Turbine components are typically nickel-based alloy that undergo oxidation at temperatures above 1800 degrees Fahrenheit. In order to allow high combustor and turbine operating conditions, ceramic coatings have been applied to blades, vanes, combustors, and seals. However, the durability of coatings is sometimes affected due to engine operating conditions.

### SUMMARY OF THE INVENTION

In accordance with the present invention, there is provided a dual layer ceramic coating with a structure which allows the coating to expand and contract with thermal cycles, thereby increasing strain tolerance which results in increased durability.

In accordance with the present invention, there is provided a turbine engine component which broadly comprises a substrate, a bond coat applied to a surface of the substrate, a first ceramic layer having a cracked structure applied on top of the bond coat, and a second ceramic layer having a cracked structure applied on top of the first ceramic layer.

Further in accordance with the present invention, there is provided a method for forming a turbine engine component. The method broadly comprises the steps of providing a substrate, applying a bond coat to a surface of the substrate, applying a first ceramic layer having a cracked structure on top of the bond coat, and applying a second ceramic layer having a cracked structure on top of the first ceramic layer.

Other details of the dual layer ceramic coating of the present invention, as well as other objects and advantages attendant thereto, are set forth in the following detailed description and the accompanying drawings wherein like reference numerals depict like elements.

### BRIEF DESCRIPTION OF THE DRAWINGS

The FIGURE is a schematic representation of a turbine engine component having a dual layer ceramic coating.

### DETAILED DESCRIPTION OF THE PREFERRED EMBODIMENT(S)

The present invention relates to a dual layer ceramic coating applied to a turbine engine component such as a blade, vane, a combustor panel or seal. The dual layer ceramic coating is capable of expanding and contracting with thermal cycles, thereby increasing strain tolerance which results in increased durability.

The turbine engine component 10 comprises a substrate 12 formed from a metallic material such as a nickel based alloy, a cobalt based alloy, a refractory metal alloy, a ceramic based or silica based alloy, or a ceramic matrix composite. A bond coat 14 is applied on top of a surface of said substrate 12. The bond coat 14 may be formed from a material selected from the group consisting of a MCrAlY, an aluminide, such as a platinum aluminide, a ceramic material, and a silica based material. The bond coat 14 may be applied using any suitable technique known in the art. Preferably, the bond coat 14 is preferably deposited using a thermal spray technique. In this technique, a spray torch may operate in a vacuum chamber at a pressure of less than 60 torr (60 mm Hg) or in another suitable atmosphere such as air. If a vacuum chamber is employed, the substrate may be heated to a temperature of between about 1500° F. and about 2000° F. If an air atmosphere is used, the substrate temperature is maintained at less than about 600° F. The bond coat may be applied by a process known as high velocity oxy-fuel (HVOF) spray. This deposition process utilizes a spray torch in which a liquid fuel or gas is combusted with oxygen to produce a high velocity gas stream into which powdered coating material is injected, heated, and propelled onto the substrate.

The particle size for the bond coat 14 may be between about 15 microns and about 100 microns, with preferably a mean particle size of about 25 microns. The bond coat may be applied to a thickness between about 5.0 mils and about 15 mils.

Following the deposition of the metallic bond coat, a dual layer ceramic coating is formed over the metallic bond coat. The first ceramic layer 16 is preferably formed from a yttria stabilized zirconia having a composition consisting of from 1.0 to 25 wt % yttria and the balance zirconia. In a preferred embodiment, the first layer is 7 wt % yttria stabilized zirconia. The second ceramic layer 18 is preferably formed from a gadolinia stabilized zirconia having a composition consisting of from 5.0 to 99 wt % gadolinia, preferably from about 30 to 70 wt % of gadolinia, and the balance zirconia. In a preferred embodiment, the second ceramic layer 18 is formed from 59 wt % gadolinia and the balance zirconia.

If desired, the first ceramic layer 16 can be formed from the aforementioned gadolinia stabilized zirconia and the second ceramic layer 18 can be formed from the aforementioned yttria stabilized zirconia.

Each of the first and second ceramic layers 16 and 18 is formed by applying the respective technique using thermal spray parameters that create a cracked (segmented) structure, which is strain compliant, and is more resistant to spallation. A preferred technique for forming the coating of the present invention is by thermal spray, more specifically plasma spray. A preferred spray angle is approximately 90 degrees; however, the spray angle will vary with complex part geometry. The gun to part distance may vary from 2.0 to 5.0 inches. In this technique, a carrier gas is used. It is preferred to use a carrier gas flow rate between 5.0 and 20 SCFH (standard cubic feet per hour). The spray parameters, such as primary gas flow, secondary gas flow, gun voltage, and gun amperage will vary with the type of equipment being used.

The cracked structure of the layers 16 and 18 allow the dual layer ceramic coating to expand and contract with thermal cycles, thereby increasing strain tolerance which results in increased durability. The gadolinia stabilized zirconia, such as 59 wt % gadolinia stabilized zirconia, has approximately one half of the thermal conductivity of yttria stabilized zirconia, such as 7 wt % yttria stabilized zirconia, while the yttria stabilized zirconia, such as 7 wt % yttria stabilized zirconia, has greater toughness.

Each of the layers 16 and 18 may have a thickness of from 5.0 to 50 mils.

One advantage to the dual layer ceramic coating of the present invention is that it has increased durability while providing a reduction in thermal conductivity.

Another advantage to the ceramic coating is that there is no graded zone. The system with a low conductivity ceramic material on top with a yttria stabilized zirconia material on bottom is more abradable as compared to a reverse system. Still further, the layers of the coating system of the present invention are interchangeable depending upon the application.

It is apparent that there has been provided in accordance with the present invention a dual layer ceramic coating which fully satisfies the objects, means, and advantages set forth hereinbefore. While the present invention has been described in the context of specific embodiments thereof, other unforeseeable alternatives, modifications, and variations may become apparent to those skilled in the art having read the foregoing description. Accordingly, it is intended to embrace those alternatives, modifications, and variations as fall within the broad scope of the appended claims.

What is claimed is:

1. A turbine engine component comprising:
a substrate;
a bond coat applied to a surface of said substrate;
a first ceramic layer having a cracked structure applied on top of said bond coat; and
a second ceramic layer having a cracked structure applied on top of said first ceramic layer.

2. The turbine engine component according to claim 1, wherein said first ceramic layer comprises a yttria stabilized zirconia and said second ceramic layer comprises a gadolinia stabilized zirconia.

3. The turbine engine component according to claim 2, wherein said yttria stabilized zirconia consists of from 1.0 to 25 wt % yttria and the balance zirconia and said second ceramic layer comprises from 30 to 70 wt % gadolinia and the balance zirconia.

4. The turbine engine component according to claim 2, wherein said yttria stabilized zirconia consists of 7 wt % yttria and the balance zirconia and the said gadolinia stabilized zirconia consists of 59 wt % gadolinia and the balance zirconia.

5. The turbine engine component according to claim 1, wherein said second ceramic layer comprises a yttria stabilized zirconia and said first ceramic layer comprises a gadolinia stabilized zirconia.

6. The turbine engine component according to claim 5, wherein said yttria stabilized zirconia consists of from 1.0 to 25 wt % yttria and the balance zirconia and said first ceramic layer comprises from 30 to 70 wt % gadolinia and the balance zirconia.

7. The turbine engine component according to claim 5, wherein said yttria stabilized zirconia consists of 7 wt % yttria and the balance zirconia and the said gadolinia stabilized zirconia consists of 59 wt % gadolinia and the balance zirconia.

8. The turbine engine component according to claim 1, wherein said bond coat is a metallic bond coat.

9. The turbine engine component according to claim 1, wherein said turbine engine component comprises a blade.

10. The turbine engine component according to claim 1, wherein said turbine engine component comprises a vane.

11. The turbine engine component according to claim 1, wherein said turbine engine component comprises a combustor panel.

12. The turbine engine component according to claim 1, wherein said turbine engine component comprises a seal.

13. The turbine engine component according to claim 1, wherein said substrate is formed from a material selected from the group consisting of a nickel based alloy, a cobalt based alloy, a refractory metal alloy, a ceramic based alloy, a silica based alloy, and a ceramic matrix composite.

14. The turbine engine component according to claim 1, wherein each of said first and second ceramic layers has a thickness in the range of from 5.0 to 50 mils.

15. A method for forming a turbine engine component comprising the steps of:
providing a substrate;
applying a bond coat to a surface of said substrate;
applying a first ceramic layer having a cracked structure on top of said bond coat; and
applying a second ceramic layer having a cracked structure on top of said first ceramic layer.

16. The method according to claim 15, wherein said first ceramic layer applying step comprises applying a first layer comprising a yttria stabilized zirconia and wherein said second ceramic layer applying step comprises applying a second layer comprising a gadolinia stabilized zirconia.

17. The method according to claim 15, wherein said first ceramic layer applying step comprises applying a first layer comprising a yttria stabilized zirconia consisting of from 1.0 to 25 wt % yttria and the balance zirconia and wherein said second ceramic layer applying step comprises applying a second layer comprising a gadolinia stabilized zirconia consisting of from 30 to 70 wt % gadolinia and the balance zirconia.

18. The method according to claim 15, wherein said first ceramic layer applying step comprises applying a first layer comprising a yttria stabilized zirconia consisting of 7.0 wt % yttria and the balance zirconia and wherein said second ceramic layer applying step comprises applying a second layer comprising a gadolinia stabilized zirconia consisting of 59 wt % gadolinia and the balance zirconia.

19. The method according to claim 15, wherein said first ceramic layer applying step comprises applying a first layer comprising a gadolinia stabilized zirconia and wherein said second ceramic layer applying step comprises applying a second layer comprising a yttria stabilized zirconia.

20. The method according to claim 15, wherein said first ceramic layer applying step comprises applying a first layer comprising a gadolinia stabilized zirconia consisting of from 30 to 70 wt % yttria and the balance zirconia and wherein said second ceramic layer applying step comprises applying a second layer comprising a yttria stabilized zirconia consisting of from 1.0 to 25 wt % yttria and the balance zirconia.

21. The method according to claim 15, wherein said first ceramic layer applying step comprises applying a first layer comprising a gadolinia stabilized zirconia consisting of 59 wt % gadolinia and the balance zirconia and wherein said second ceramic layer applying step comprises applying a second layer comprising a yttria stabilized zirconia consisting of 7.0 wt % yttria and the balance zirconia.

22. The method according to claim 15, wherein said bond coat applying step comprises applying a metallic bond coat.

23. The method according to claim 15, wherein each of said first and second ceramic layers is applied using a plasma spray technique.
